(19) United States
(12) Patent Application Publication
(10) Pub. No.: US 2023/0362939 A1
(43) Pub. Date: Nov. 9, 2023

(54) CONFIGURING UPLINK CONTROL CHANNELS

(71) Applicant: Telefonaktiebolaget LM Ericsson (publ), Stockholm (SE)

(72) Inventors: Namir LIDIAN, Solna (SE); Yi-Ju CHEN, Solna (SE); Sairamesh NAMMI, Kista (SE)

(21) Appl. No.: 18/023,868

(22) PCT Filed: Aug. 28, 2020
(86) PCT No.: PCT/EP2020/074161

§ 371 Date: Feb. 28, 2023

(51) Int. Cl. H04W 72/21; H04W 72/541; H04B 7/06; H04L 1/1812

(52) U.S. Cl. CPC H04W 72/21; H04B 7/0626; H04L 1/1812; H04W 72/541

(57) ABSTRACT

A network node in a communications network can configure communication device with a plurality of uplink control channel configurations each having a different number of orthogonal frequency division multiplexing, OFDM, symbols. The network node can further transmit an indication of a selected uplink control channel configuration of the plurality of uplink control channel configurations to the communication device on a downlink control channel.

### TECHNICAL FIELD

The present disclosure is related to wireless communication systems and more particularly to configuring uplink control channels.

### BACKGROUND

FIG. 1 illustrates an example of a 5^{th} Generation (“5G”) network (also referred to as a new radio (“NR”) network) including a network node 102 (e.g., a 5G base station (“gNB”)) and multiple communication devices 104 (also referred to as user equipment (“UE”)).

The 3^{rd} generation partnership project (“3GPP”) specified that 5G networks should meet the increasing demand for data-centric applications. In particular, the 3GPP indicated the following requirements for 5G networks: data rates of several tens of megabits per second should be supported for tens of thousands of users; 1 gigabit per second to be offered simultaneously to tens of workers on the same office floor; several hundreds of thousands of simultaneous connections to be supported for massive sensor deployments; spectral efficiency should be enhanced compared to 4G; improved coverage; enhanced signaling efficiency; and reduced latency compared to LTE.

From a services aspect, the NR specification supports mainly three services: enhanced mobile broadband (“eMBB”); ultra reliable low latency communication (“URLLC”); and massive machine-type communications (“mMTC”). The eMBB can be used for high broadband applications where the data rate is a primary concern. The URLLC can be used for ultra-reliable communications where the packet error rate of 10⁻⁶ is required with less delay. The mMTC can be used for connecting machine-type communications, where the number of devices is a primary concern.

### SUMMARY

According to some embodiments, a method performed by a network node in a communications network is provided. The method can include configuring a communication device with a plurality of uplink control channel configurations. Each of the uplink control channel configurations of the plurality of uplink control channel configurations can have a different number of orthogonal frequency multiplexing (“OFDM”) symbols. The method can further include transmitting an indication of a selected uplink control channel configuration of the plurality of uplink control channel configurations to the communication device on a downlink control channel.

According to other embodiments, a method performed by a communication device in a communications network that includes a network node is provided. The method can include receiving an indication of a selected uplink control channel configuration of a plurality of uplink control channel configurations from the network node via a downlink control channel. Each uplink control channel configuration of the plurality of uplink control channel configurations can have a different number of orthogonal frequency division multiplexing (“OFDM”) symbols. The method can further include transmitting a hybrid automatic repeat request (“HARQ”) acknowledgment (“ACK”) message to the network node. The HARQ ACK message can have an uplink control channel format and a number of OFDM symbols indicated by the selected uplink control channel configuration.

According to other embodiments, a communication device, a network node, computer program, and/or computer program product is provided for performing one or more of the above methods.

Various embodiments described herein improve overall network performance. Some embodiments allow for better use of network resources by adapting the number of symbols for PUCCH transmission. Due to the reduction of unnecessary long PUCCH, the length of the transmitted PUCCH can be reduced by decreasing a number of symbols so that the optimum number of resource utilization of PUCCH is used. Therefore, the network can use the remaining resources for data traffic channels PUSCH, sending sounding reference signals (“SRS”), or allocate these resources for another UE for transmitting HARQ-ACK, CSI, SRS, or PUSCH.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a signal flow diagram illustrating an example of message sequences between the network and the UE in accordance with some embodiments;

FIG. 3 is a table illustrating an example of physical uplink control channel (“PUCCH”) formats in new radio (“NR”);

FIG. 4 is a graph illustrating an example of block error rate (“BER”) for different PUCCH formats in accordance with some embodiments;

FIG. 5 is a signal flow diagram illustrating an example a message sequence between the network and the UE in accordance with some embodiments;

FIG. 6 is a block diagram illustrating an example of a communication device in accordance with some embodiments;

FIG. 7 is a block diagram illustrating an example of a radio access network (“RAN”) node in accordance with some embodiments;

FIG. 8 is a block diagram illustrating an example of a core network (“CN”) node in accordance with some embodiments;

FIG. 9 is a flow chart illustrating examples of operations performed by a network node in accordance with some embodiments;

FIG. 10 is a flow chart illustrating examples of operations performed by a communication device in accordance with some embodiments;

FIG. 11 is a block diagram of a wireless network in accordance with some embodiments;

FIG. 12 is a block diagram of a user equipment in accordance with some embodiments;

FIG. 13 is a block diagram of a virtualization environment in accordance with some embodiments;

FIG. 14 is a block diagram of a telecommunication network connected via an intermediate network to a host computer in accordance with some embodiments;

FIG. 15 is a block diagram of a host computer communicating via a base station with a user equipment over a partially wireless connection in accordance with some embodiments;

FIG. 16 is a block diagram of methods implemented in a communication system including a host computer, a base station, and a user equipment in accordance with some embodiments;

FIG. 17 is a block diagram of methods implemented in a communication system including a host computer, a base station, and a user equipment in accordance with some embodiments;

FIG. 18 is a block diagram of methods implemented in a communication system including a host computer, a base station, and a user equipment in accordance with some embodiments; and

FIG. 19 is a block diagram of methods implemented in a communication system including a host computer, a base station, and a user equipment in accordance with some embodiments.

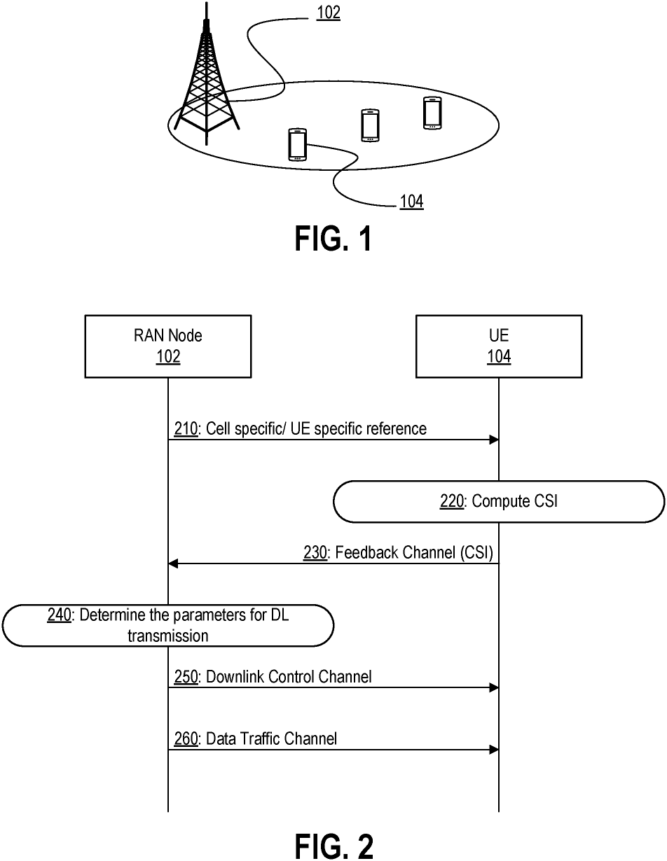

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

FIG. 2 illustrates an example of a message sequence chart for downlink data transfer in a 5G system. At operation 210, the RAN node 102 transmits cell specific or UE specific reference signals to the UE 104. At operation 220, the UE 104 computes channel state information (“CSI”). The UE 104 can compute the CSI and parameters used for CSI reporting from the pilot or reference signals. The CSI report can include, for example, one or more of a channel quality indicator (“CQI”), precoding matrix index (“PMI”), rank information (“RI”) and/or CSI-reference signal (“CSI-RS”) Resource Indicator (“CRI”).

At operation 230, the UE 104 can transmit the CSI report to the RAN node 102 via a feedback channel. The CSI report may be transmitted in response to a request from the RAN node 102 or periodically. At operation 240, a network scheduler of the RAN node 102 uses the information in the CSI report to determine parameters for downlink (“DL”) transmission to the UE 104. The parameters for DL transmission can include a modulation and coding scheme (“MCS”), a power, and/or physical resource blocks (“PRBs”). At operation 250, the RAN node 102 transmits the scheduling parameters to the UE 104 in a downlink control channel, e.g. a physical downlink control channel (“PDDCH”). At operation 260, RAN node 102 transmits actual data to the UE 104 via a data traffic channel, e.g. a physical downlink shared channel (“PDSCH”).

Downlink reference signals are predefined signals occupying specific resource elements within a downlink time-frequency grid. There are several types of downlink reference signals that are transmitted in different ways and used for different purposes by the receiving terminal, for example, CSI-RS and demodulation reference signals (“DM-RS”).

CSI-RS include reference signals that are specifically intended to be used by terminals to acquire CSI and beam-specific information (e.g., beam reference signal received power (“RSRP”)). In 5G, CSI-RS can be UE specific so the CSI-RS can have a significantly lower time/frequency density.

DM-RS include reference signals (sometimes referred to as UE-specific reference signals) that are specifically intended to be used by terminals for channel estimation for data channel. The label “UE-specific” relates to the fact that each DM-RS is intended for channel estimation by a single terminal. That specific reference signal is then only transmitted within the resource blocks assigned for data traffic channel transmission to that terminal.

An uplink control channel (e.g. the physical uplink control channel, “PUCCH”) can carry information about hybrid automatic repeat request (“HARQ”)-acknowledgement (“ACK”) information corresponding to the downlink data transmission, scheduling requests indicating that a device needs uplink resources for physical uplink shared channel (“PUSCH”) transmission, and CSI. The CSI can include layer 1 (“L1”)-RSRP, CSI-RS resource indicator (“CRI”), RI, CQI, and PMI.

A downlink control channel (e.g. PDCCH) can carry information about scheduling grants. This information can be referred to as downlink control information (“DCI”). The information can include a number of multiple-input-multiple-output (“MIMO”) layers scheduled, transport block sizes, modulation for each codeword, parameters related to HARQ, sub band locations, and also PMI corresponding to that sub band. Not all DCI formats may transmit all the information as shown above. The contents of a downlink control channel can depend on transmission mode and DCI format.

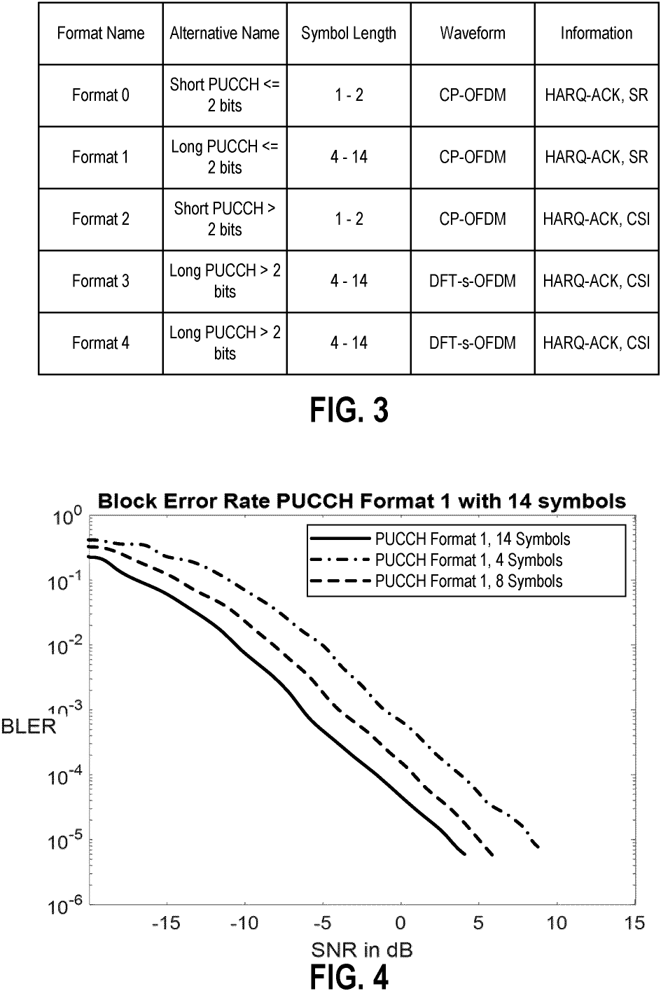

The 3GPP has defined five PUCCH formats for reporting HARQ-ACK, scheduling request (“SR”), and CSI. FIG. 3 includes a table that summarizes the characteristics of each PUCCH format. Typically, formats 0 and 1 are only used for sending HARQ-ACK. Long PUCCH formats are used for HARQ-ACK, CSI. Various embodiments described herein are associated with PUCCH format 0 and format 1 for sending HARQ-ACK, SR from a UE to a gNB for both eMBB and URLLC applications.

A PUCCH resource can include one or more of the following parameters that define a PUCCH: an index of the first symbol; a number of OFDM symbols; an index of the first PRB prior to frequency hopping or for no frequency hopping; an index of the first PRB after frequency hopping; a number of PRBs; frequency hopping (e.g., frequency hopping for a PUCCH resource is either enabled or disabled); an index of the cyclic shift; an index of an orthogonal cover code; an index of an orthogonal cover code (e.g., the index of the orthogonal cover code is from a set of {0, 1, 2, 3} and is indicated by higher layer parameter PUCCH-F4-preDFT-OCC-index); and a spreading factor for an orthogonal cover code (e.g., the spreading factor of PUCCH format 4 is from a set of {2, 4} and is indicated by higher layer parameter PUCCH-F4-preDFT-OCC-length).

One of the design problems for a network that supports both enhanced mobile broadband (“eMBB”) and ultra reliable low latency communication (“URLLC”) is the configuration of an uplink control channel. The performance requirements for eMBB may not be the same as the performance requirements of URLLC. Therefore, each application may configure its own PUCCH formats. For example, if a UE is configured with PUCCH format 1, it may satisfy the eMBB requirement but may not satisfy the URLLC requirement. If the URLLC design is used for eMBB, then PUCCH may occupy extra resources and reduce the resources required for PUSCH. Accordingly, it can be beneficial to efficiently configure the uplink control channel to cater for all services for 5G (e.g., eMBB and URLLC with requirements of high reliability and low latency) at the same time efficiently using the resources for PUCCH.

Various embodiments described herein configure the uplink control channel for serving both eMBB and URLLC services and/or to accommodate differing network conditions. In some embodiments, instead of configuring a UE with one PUCCH configuration to cater for all the services and/or network conditions, the network configures multiple PUCCH resource configurations and indicates the chosen PUCCH resource using a downlink control channel. Each of the PUCCH resource configurations can be associated with a different number of OFDM symbols. In additional or alternative embodiments, the network node (e.g., gNB) determines the PUCCH resource based on the service, based on geometry, based on the position of the UE in the cell, and/or based on the long term signal-to-noise and interference ratio (“SINR”) or RSRP. The multiple PUCCH resource configurations can be configured through higher layer signaling (e.g., radio resource control (“RRC”) signaling), whereas the indication of the selected PUCCH resource configuration can be provided to the UE through a downlink control channel (e.g., in DCI).

In some embodiments, a network node can configure a UE with the multiple PUCCH resource configurations, where each configuration is different in the number of OFDM symbols. In other words, each of the PUCCH resource configurations the UE is configured with may specify a different number of OFDM symbols for the PUCCH resource. In additional or alternative embodiments, the network node can determine which format is best suitable for the given services such as eMBB or URLLC. In additional or alternative embodiments, the network node can determine which format is best suitable for different application requirements within the same service. In additional or alternative embodiments, the network node can indicate to the UE which format and the required number of symbols to use for PUCCH dynamically based on the traffic served or the measured SINR for a certain period of time or position of the UE, geometry, or RSRP of the UE. In additional or alternative embodiments, the network node can receive a HARQ-ACK from the UE with the format and the number of symbols based on the configuration it received from the network node using downlink control channel.

Various embodiments described herein allow for better use of network resources by adapting the number of symbols for PUCCH transmission. Due to the reduction of unnecessary long PUCCH, the length of the transmitted PUCCH can be reduced by decreasing a number of symbols so that the optimum number of resource elements for the PUCCH is used. This enables the network to use the remaining resources for data traffic channels (e.g., PUSCH), sending sounding reference signals (“SRS”), or allocating these resources for another UE for transmitting HARQ-ACK, CSI, SRS, or PUSCH. Accordingly, the overall network performance can be improved. Furthermore, by configuring multiple PUCCH resource configurations but indicating the selected resource configuration through the downlink control channel, the PUCCH resource configuration can be adapted readily and efficiently. Thus, embodiments of the present disclosure can facilitate the dynamic adaptation of PUCCH resource configurations (including the associated number of OFDM symbols of the PUCCH) at the UE, for example, based on network conditions and/or the type of service being supported by the UE.

As used herein in relation to the disclosed embodiments, the term user equipment (“UE”) refers to any type of wireless device that communicates with a radio network node in a cellular or mobile communication system. In some examples, a UE includes a target device, a device to device (“D2D”) UE, a machine type UE or UE capable of machine to machine (“M2M”) communication, a personal data assistant (“PDA”), an iPAD, a tablet, a mobile terminal, a smart phone, a laptop embedded equipped (“LEE”), laptop mounted equipment (“LME”), or a universal serial bus (“USB”) dongle.

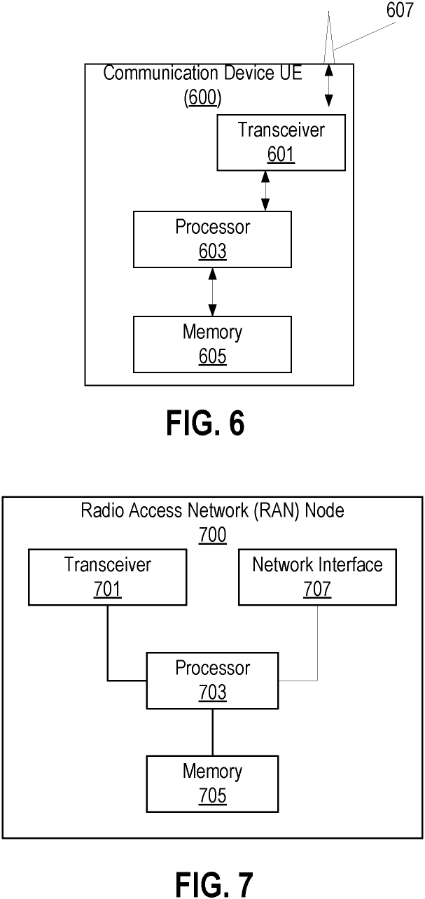

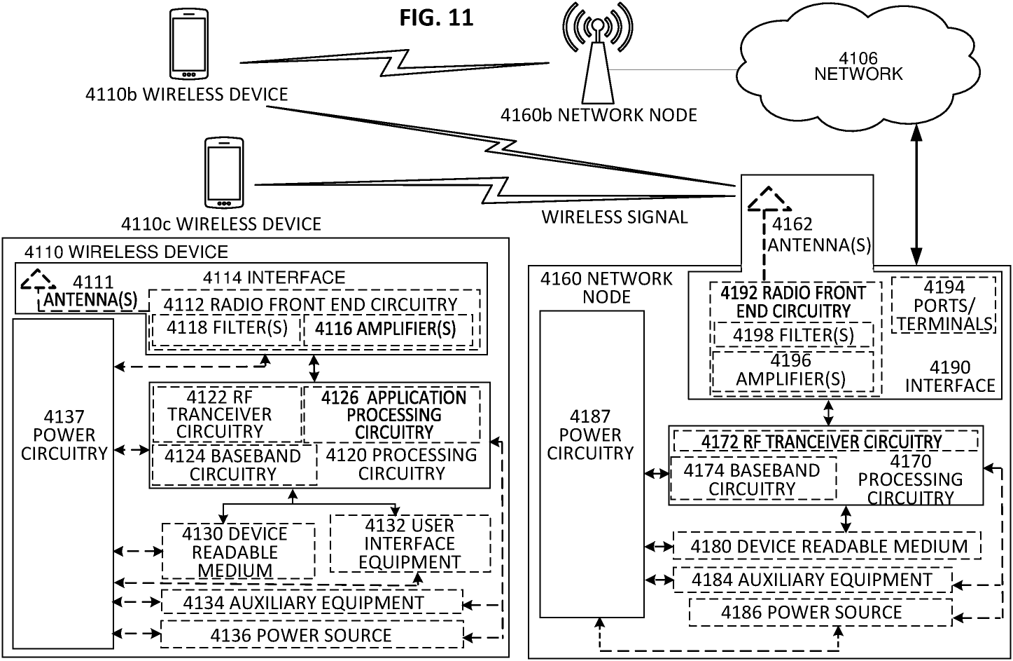

FIG. 6 is a block diagram illustrating elements of a communication device 600 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 600 may be provided, for example, as discussed below with respect to wireless device 4110 of FIG. 11.) As shown, communication device 600 may include an antenna 607 (e.g., corresponding to antenna 4111 of FIG. 11), and transceiver circuitry 601 (also referred to as a transceiver, e.g., corresponding to interface 4114 of FIG. 11) including a transmitter and a receiver configured to provide uplink and downlink radio communications with a base station(s) (e.g., corresponding to network node 4160 of FIG. 11, also referred to as a RAN node) of a radio access network. Communication device 600 may also include processing circuitry 603 (also referred to as a processor, e.g., corresponding to processing circuitry 4120 of FIG. 11) coupled to the transceiver circuitry, and memory circuitry 605 (also referred to as memory, e.g., corresponding to device readable medium 4130 of FIG. 11) coupled to the processing circuitry. The memory circuitry 605 may include computer readable program code that when executed by the processing circuitry 603 causes the processing circuitry to perform operations according to embodiments disclosed herein. According to other embodiments, processing circuitry 603 may be defined to include memory so that separate memory circuitry is not required. Communication device 600 may also include an interface (such as a user interface) coupled with processing circuitry 603, and/or communication device UE may be incorporated in a vehicle.

As discussed herein, operations of communication device 600 may be performed by processing circuitry 603 and/or transceiver circuitry 601. For example, processing circuitry 603 may control transceiver circuitry 601 to transmit communications through transceiver circuitry 601 over a radio interface to a radio access network node (also referred to as a base station) and/or to receive communications through transceiver circuitry 601 from a RAN node over a radio interface. Moreover, modules may be stored in memory circuitry 605, and these modules may provide instructions so that when instructions of a module are executed by processing circuitry 603, processing circuitry 603 performs respective operations.

In some embodiments the term radio network node or network node refers to any type of network node that serves a UE and/or is connected to another network node, network element, or any radio node from where UE receives signal. In some examples, a radio network node includes: a Node B, a base station (“BS”), a multi-standard radio (“MSR”) node such as a MSR BS, a gNB, a network controller, a radio network controller (“RNC”), a base station controller (“BSC”), a relay, a donor node controlling relay, a base transceiver station (“BTS”), an access point (“AP”), a transmission point, a transmission node, a remote radio unit (“RRU”), a remote radio head (“RRH”), or a node in distributed antenna system (“DAS”).

FIG. 7 is a block diagram illustrating elements of a radio access network (“RAN”) node 700 (also referred to as a network node, base station, eNodeB/eNB, gNodeB/gNB, etc.) of a Radio Access Network (RAN) configured to provide cellular communication according to embodiments of inventive concepts. (RAN node 700 may be provided, for example, as discussed below with respect to network node 4160 of FIG. 11.) As shown, the RAN node 700 may include transceiver circuitry 701 (also referred to as a transceiver, e.g., corresponding to portions of interface 4190 of FIG. 11) including a transmitter and a receiver configured to provide uplink and downlink radio communications with mobile terminals. The RAN node 700 may include network interface circuitry 707 (also referred to as a network interface, e.g., corresponding to portions of interface 4190 of FIG. 11) configured to provide communications with other nodes (e.g., with other base stations) of the RAN and/or core network CN. The RAN node 700 may also include processing circuitry 703 (also referred to as a processor, e.g., corresponding to processing circuitry 4170) coupled to the transceiver circuitry, and memory circuitry 705 (also referred to as memory, e.g., corresponding to device readable medium 4180 of FIG. 11) coupled to the processing circuitry. The memory circuitry 705 may include computer readable program code that when executed by the processing circuitry 703 causes the processing circuitry to perform operations according to embodiments disclosed herein. According to other embodiments, processing circuitry 703 may be defined to include memory so that a separate memory circuitry is not required.

As discussed herein, operations of the RAN node 700 may be performed by processing circuitry 703, network interface 707, and/or transceiver 701. For example, processing circuitry 703 may control transceiver 701 to transmit downlink communications through transceiver 701 over a radio interface to one or more mobile terminals UEs and/or to receive uplink communications through transceiver 701 from one or more mobile terminals UEs over a radio interface. Similarly, processing circuitry 703 may control network interface 707 to transmit communications through network interface 707 to one or more other network nodes and/or to receive communications through network interface from one or more other network nodes. Moreover, modules may be stored in memory 705, and these modules may provide instructions so that when instructions of a module are executed by processing circuitry 703, processing circuitry 703 performs respective operations (e.g., operations discussed below with respect to Example Embodiments relating to network nodes).

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

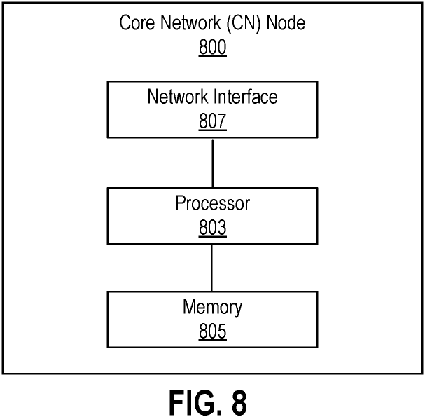

FIG. 8 is a block diagram illustrating elements of a core network (“CN”) node 800 (e.g., an SMF node, an AMF node, an AUSF node, a UDM node, etc.) of a communication network configured to provide cellular communication according to embodiments of inventive concepts. As shown, the CN node 800 may include network interface circuitry 807 (also referred to as a network interface) configured to provide communications with other nodes of the core network and/or the RAN. The CN node 800 may also include a processing circuitry 803 (also referred to as a processor) coupled to the network interface circuitry, and memory circuitry 805 (also referred to as memory) coupled to the processing circuitry. The memory circuitry 805 may include computer readable program code that when executed by the processing circuitry 803 causes the processing circuitry to perform operations according to embodiments disclosed herein. According to other embodiments, processing circuitry 803 may be defined to include memory so that a separate memory circuitry is not required.

As discussed herein, operations of the CN node 800 may be performed by processing circuitry 803 and/or network interface circuitry 807. For example, processing circuitry 803 may control network interface circuitry 807 to transmit communications through network interface circuitry 807 to one or more other network nodes and/or to receive communications through network interface circuitry from one or more other network nodes. Moreover, modules may be stored in memory 805, and these modules may provide instructions so that when instructions of a module are executed by processing circuitry 803, processing circuitry 803 performs respective operations.

Some embodiments are described herein for NR. However, the embodiments are applicable to any radio access technology (“RAT”) or multi-RAT system where the UE can operate using multiple carriers (e.g. long term evolution (“LTE”) frequency division duplex (“FDD”)/time division duplex (“TDD”), global system for mobile communication (“GSM”)/GSM EDGE radio access network (“GERAN”), WiFi, WLAN, WiMax, or CDMA2000).

Some embodiments are applicable to a single carrier, multicarrier (“MC”), and/or carrier aggregation (“CA”) operation of the UE. The term carrier aggregation (“CA”) can also be referred to as “multi-carrier system”, “multi-cell operation”, “multi-carrier operation”, and “multi-carrier” transmission and/or reception.

Some embodiments are also applicable to transmission from multiple transmission reception points (“TRPs”).

In accordance with the present disclosure, the UE can be configured with multiple PUCCH resource configurations rather than a single PUCCH resource configuration. Each PUCCH resource configuration can include a different number of OFDM symbols to the other PUCCH resource configurations the UE is configured with. That is, the UE can be configured with a set of PUCCH configurations, where the number of OFDM symbols for each PUCCH configuration in the set is different. The number of OFDM symbols refers to the number of OFDM symbols of the PUCCH. That is, a PUCCH resource configuration indicates a number of parameters for the PUCCH (as detailed above), where one of those parameters is the number of OFDM symbols of the PUCCH. A motivation for configuring the UE with multiple PUCCH configurations having a variable number of OFDM symbols is described mathematically below.

Let P_{R} be the probability of correct reception of the NR packet at the application layer. The NR packet can be either eMBB or URLLC. Then for downlink packets transmission, P_{R} can depend on: a probability of correct reception of downlink control channel (“P_{dci}”); a probability of correct reception of PDSCH (“P_{pdsch}”); and a probability of correct reception of HARQ-ACK (“P_{pucch}”) transmitted on PUCCH.

Since these three events are independent from the network point of view, the joint probability of correct reception at the application layer can be given by:

$${\text{P}}_{\text{R}} = \left(1 - {\text{P}}_{\text{dci}}\right) \left(1 - {\text{P}}_{\text{pdsch}}\right) \left(1 - {\text{P}}_{\text{pucch}}\right) \qquad \text{(1)}$$

The probability of error P_{pucch} can be written as:

$${P}_{p u c c h} = 1 - \frac{{P}_{R}}{\left(1 - {P}_{p d s c h}\right) \left(1 - {P}_{d c i}\right)} \qquad \text{(2)}$$

Since P_{pucch} is a probability and can’t be greater than unity or less than zero, then

$${P}_{R} \leq \left(1 - {P}_{p d s c h}\right) ( 1 - \left({P}_{d c i}\right) \qquad \text{(3)}$$

Similarly:

$${P}_{R} \leq \left(1 - {P}_{p d s c h}\right) ( 1 - \left({P}_{p u c c h}\right) \qquad \text{(4)}$$

To satisfy these equalities, it follows that:

$${P}_{p u c c h} \leq 1 - \frac{{P}_{R}}{1 - {P}_{p d s c h}} \qquad \text{(5)}$$

It follows from equation (5) that the less the probability of error P_{pdsch}, the lower the probability of error P_{pucch}. Therefore, PUCCH reliability can depend on the reliability requirements of PDSCH. However, the reliability requirements of eMBB and URLLC channels are different. For example, for Release 15 URLLC, P_{pdsch} is 10⁻⁵, for Release 16 the requirement for P_{pdsch} is 10⁻⁶, and for eMBB, P_{pdsch} is 10⁻¹. Therefore, in order for the same design for PUCCH to be used for eMBB and URLLC, the number of resources is controlled by the design of URLLC (since this has the stricter error requirements), which can require a robust design. However, if the network schedules the eMBB packet with the same design as that used for URLLC, the number of PUCCH resources can be wasted for eMBB, which can be given to PUSCH for improving the uplink throughput.

The present disclosure can address these issues by configuring the UE with multiple PUCCH resource configurations, for example, using RRC signaling. A PUCCH resource can includes one or more of the following parameters: an index of the first symbol; a number of OFDM symbols; an index of the first PRB prior to frequency hopping or for no frequency hopping; an index of the first PRB after frequency hopping; a number of PRBs; frequency hopping (e.g., frequency hopping for a PUCCH resource can be either enabled or disabled); an index of the cyclic shift; an index of an orthogonal cover code; and a spreading factor for an orthogonal cover code. A PUCCH resource configuration can indicate values, or settings, for some or all of these parameters that specify the PUCCH. The term ‘PUCCH resource configuration’ may be referred to herein as a ‘PUCCH configuration’.

A UE can be configured with a number of sets of PUCCH resources by higher layer parameter, PUCCH-resourceSet, where the number of PUCCH resources in each set of PUCCH resources is provided by higher layer parameter, maxNrofPUCCH-ResourcesPerSet, and where a PUCCH resource in a set of PUCCH resources is indicated by higher layer parameter, PUCCH-resource-id.

FIG. 4 is a graph illustrating simulations obtained by the inventors for PUCCH Format 1 in which a different number of OFDM symbols are allocated. In this example, the gNB can decide to use PUCCH format 1 requesting HARQ-ACK from the UE. The gNB can configure the UE with multiple PUCCH configurations: a first PUCCH configuration with 14 symbols, a second PUCCH configuration with 8 symbols, and a third PUCCH configuration with 4 symbols. For each configuration the UE can send a HARQ-ACK. It will be appreciated that these symbol numbers have been chosen for illustrative purposes only, and that in other implementations the PUCCH configurations might have different numbers of symbols to this example. Furthermore, although three PUCCH configurations are illustrated here, the UE can be configured with other numbers of PUCCH configurations.

For the first PUCCH configuration, the DMRS occupies 7 OFDM symbols (symbols 1, 3, 5, 7, 9, 11, and 13) and HARQ-ACK sequence occupies 7 OFDM symbols (symbols 2, 4, 6, 8, 10, 12, and 14).

For the second PUCCH configuration, the DMRS occupies 4 OFDM symbols (symbols 1, 3, 5, and 7) and HARQ-ACK sequence occupies 4 OFDM symbols (symbols 2, 4, 6, and 8).

For the third PUCCH configuration, the DMRS occupies 2 OFDM symbols (symbols 1 and 3) and HARQ-ACK sequence occupies 2 OFDM symbols (symbols 2 and 4).

It is observed that the long sequence of HARQ-ACK is mapped to the PUCCH symbols and the sequence is not repeated like conventional HARQ-ACK repetition techniques in 3G and 4G. Similarly, the DMRS sequence sent in each symbol is different. The performance of each PUCCH configuration is different as shown in the simulation results.

It can be observed from FIG. 4 that the performance (measured in this example in terms of the block error rate (“BLER”)) is impacted by the number of OFDM symbols of the PUCCH. This indicates different PUCCH resource configurations can be used by the UE depending on circumstance to optimize usage of the available resources.

For example, in some embodiments, a network configures multiple PUCCH resource configurations (where each resource configuration is differed by the number of OFDM symbols) to cater for different services but with the same PUCCH format. This can be useful for gNB implementation as the gNB can avoid implementing different receivers for each PUCCH formats as defined in the specification, but use only one receiver for decoding PUCCH. In a more specific example, the network uses two types of PUCCH configurations: one for eMBB and another for URLLC. Each PUCCH configuration might be adapted to support a different data service. For example, PUCCH format 1 can be allocated 14 OFDM symbols for URLLC services, and a PUCCH resource configuration with 4 symbols can be allocated for eMBB services. Alternatively, the network node can configure the UE with multiple PUCCH configurations and, at the time of scheduling, choose the configuration with the highest number of OFDM symbols if the data packet to be transmitted is an URLLC packet. Similarly, it can choose the PUCCH resource with the lowest number of OFDM symbols if the data packet to be transmitted is an eMBB packet. The network node can indicate the chosen configuration to the UE in the downlink control channel (e.g. in DCI)

The network can dynamically indicate to the UE (e.g. through DCI) which PUCCH resources to use to transmit the HARQ-ACK/SR in the downlink control channel and then PUCCH resources can be efficiently used.

In additional or alternative embodiments, the network (e.g., gNB) configures multiple PUCCH configurations to cater for different levels of signal-to-interference-plus-noise ratio (“SINR”) or geometry of the UE. As a specific example, the network node can configure three PUCCH configurations, for catering low, medium, and high SINR (e.g., long term geometry) UEs. The network can select a PUCCH configuration of 14 symbols for low SINR/geometry UE’s (e.g., UEs for which the SINR is less than 5 dB), a PUCCH configuration of 8 symbols for medium SINR UE’s (e.g., UEs for which the SINR is between 5 and 15 dB), and a PUCCH configuration of 4 symbols for high SINR UEs (e.g., UEs for which the SINR is greater than 15 dB). More generally, the network node can select a PUCCH configuration with a relatively greater number of OFDM symbols for UEs with relatively low SINR (e.g., an SINR below an SINR threshold value) and select a PUCCH configuration with a relatively lower number of OFDM symbols for UEs with relatively high SINR (e.g., an SINR above an SINR value). Using this technique can save a number of OFDM resources in the uplink by adapting the resources based on the SINR of the UE (e.g., by not allocating unnecessary resources to UEs with relatively high SINR). There are multiple techniques to obtain the long term SINR of the UE. For example, the long term SINR of the UE can be determined by checking the CQI transmitted by the UE over a period of time (e.g., 50 slots), which can average out fading effects and get an estimate of the SINR of the UE. Based on the geometry or long term SINR, the network node can choose the correct PUCCH configuration and indicate to the UE dynamically using a downlink control channel (e.g., DCI).

In additional or alternative embodiments, the network configures multiple PUCCH configurations to cater for UE location within the cell, for example the distance between the UE and the network node. In one particular example, the network node can configure the UE with a PUCCH configuration for catering for cell edge locations, a PUCCH configuration for locations close to the network node, and a PUCCH configuration for middle-of-the cell UEs. The network node can select a PUCCH configuration of 14 symbols for low cell edge UEs, a PUCCH configuration of 8 symbols for middle-of-the-cell UEs, and a PUCCH configuration of 4 symbols for close to gNB UEs. More generally, the network node can select a PUCCH configuration with a relatively greater number of OFDM symbols for UEs relatively further away from the network node (e.g., for distances greater than a predetermined distance) and select a PUCCH configuration with a relatively lower number of OFDM symbols for UEs relatively closer to the network node (e.g., for distances less than the predetermined distance). Using this technique can save a number of OFDM resources in the uplink by adapting the resources based on the position of the UE. There are multiple techniques to obtain the position of the UE. For example, by using positioning techniques or by using a global positioning system (“GPS”), the gNB can get an estimate of the UE position.

In additional or alternative embodiments, the network configures multiple PUCCH configurations based on the RSRP it reported or based on the path loss estimation from uplink channel measurements.

Once the network decides the number of OFDM symbols, it can inform the UE of the chosen PUCCH configuration to the UE. The indication of the chosen PUCCH configuration can be done through higher layer signaling or in a downlink control channel, e.g. in DCI.

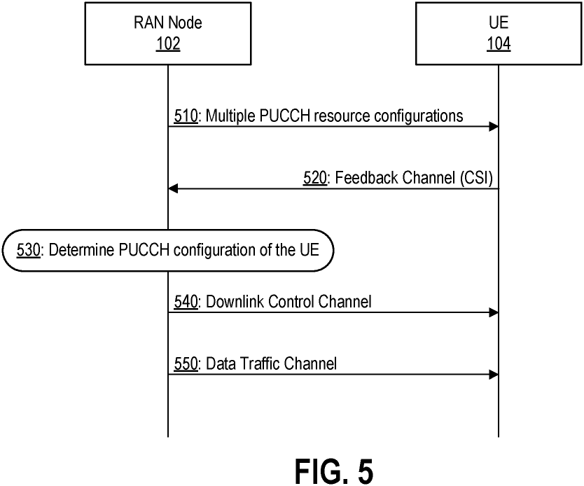

FIG. 5 illustrates an example of a message sequence chart in accordance with some embodiments.

At operation 510, the RAN node 102 transmits multiple PUCCH resource configurations to the UE 104. Operation 510 may be performed through higher layer signaling, such as RRC signaling. At operation 520, in response to receiving the multiple PUCCH resource configurations, the UE 104 transmits CSI via a feedback channel. At operation 530, the RAN node 102 determines, for example based on the CSI, a PUCCH resource configuration of the multiple PUCCH resource configurations for configuring the UE 104. At operation 540, the RAN node 102 transmits an indication of the selected PUCCH resource configuration to the UE 104 via a downlink control channel (e.g., via DCI). At operation 550, RAN node 102 transmits data to the UE 104 via the data traffic channel (e.g., via PDSCH).

In some embodiments, once the UE decodes the downlink control channel, it obtains information about which PUCCH configuration the network is expecting for HARQ-ACK/SR. The UE decodes the PDSCH and transmits the HARQ-ACK on the chosen PUCCH configuration and transmits to the network.

Various embodiments described herein configure multiple PUCCH resource configurations, where each PUCCH configuration is differed by the number of OFDM symbols, and indicate the selected PUCCH configuration to the UE by downlink control channel thereby adapting the PUCCH resources dynamically to cater for each service. Alternatively or in addition, the network node dynamically adapts the PUCCH resources in dependence on the UE position or long term SINR or the path loss of the UE. This can improve the resource utilization at the same time satisfying the reliability requirement as well as the performance requirement.

Some example embodiments of the present disclosure will now be provided below.

An operation performed by a network node is provided for configuring the UE with multiple uplink (“UL”) control channel resource configurations within the same format, and indicating to the UE a selected configuration. The UL control channel resource configuration might be indicated to the UE on the downlink control channel, for example in DCI. It might be selected based on performance criteria.

The performance criteria can be based on the SINR of the UE. The network can indicate the uplink control resource with the lowest number of symbols when the SINR is greater than a pre-determined threshold. The network can indicate the uplink control resource with the highest number of symbols when the SINR is lower than a pre-determined threshold.

In additional or alternative embodiments, the performance criteria is based on the position of the UE. The network node can indicate the uplink control resource with the lowest number of symbols when the UE is relatively close to the network node. The network node can indicate the uplink control resource with the highest number of symbols when the UE is relatively far away from the network node

In additional or alternative embodiments, the network indicates the uplink control resource with the highest number of symbols if the UE is scheduled with an URLLC service and indicates the uplink control resources with lowest number of symbols if the UE is scheduled with an eMBB service.

In additional or alternative embodiments, the network node configures the UE with multiple UL control channel resource configurations by using a pre-computed long sequence for indicating the HARQ-ACK and dynamically indicating to the UE the length of the sequence implicitly, (e.g., based on the performance criteria).

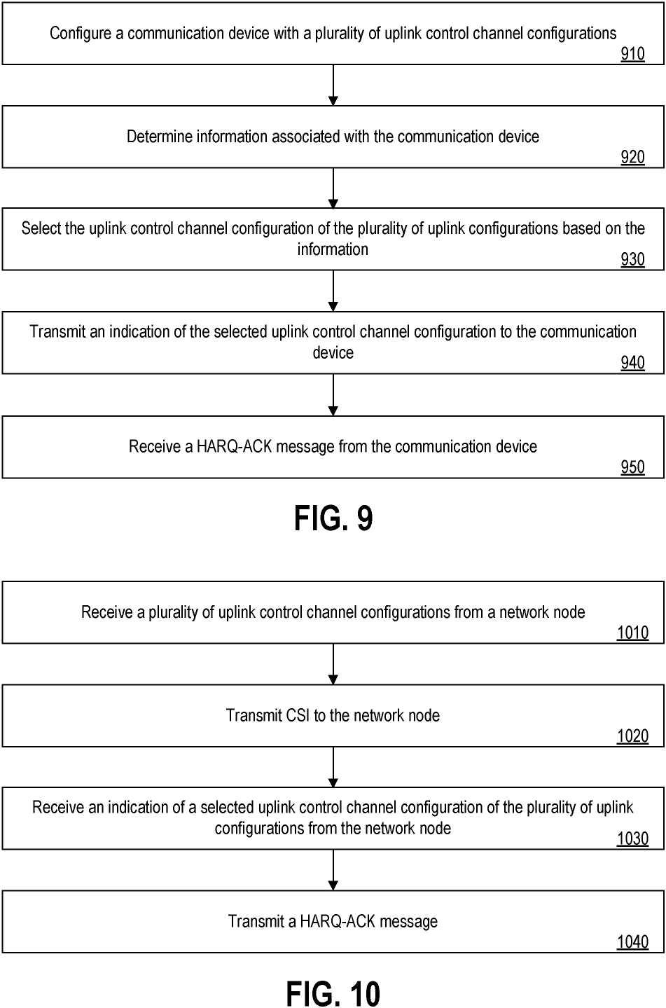

Operations of a network node will now be discussed with reference to the flow chart of FIG. 9 according to some embodiments of the present disclosure. FIG. 9 will be described below as being performed by network node 700 (implemented using the structure of the block diagram of FIG. 7). For example, modules may be stored in memory 705 of FIG. 7, and these modules may provide instructions so that when the instructions of a module are executed by respective processing circuitry 703, processing circuitry 703 performs respective operations of the flow chart. However, the operations in FIG. 9 may be performed by any suitable network node.

FIG. 9 illustrates an example of operations performed by a network node to configure an uplink control channel.

At block 910, processing circuitry 703 configures a communication device (e.g., communication device 600 of FIG. 6) with a plurality of uplink control channel configurations. Each of the uplink control channel configurations of the plurality of uplink control channel configurations can have a different number of orthogonal frequency division multiplexing (“OFDM”) symbols. In some embodiments, the network node configures the communication device by transmitting, via transceiver 701, the plurality of uplink control channel configurations to the communication device. In additional or alternative embodiments, the plurality of uplink control channel configurations include a plurality of physical uplink control channel (“PUCCH”) resource configurations. In additional or alternative embodiments, the plurality of uplink control channel configurations are transmitted via radio resource control (“RRC”) signaling.

At block 920, processing circuitry 703 determines information associated with the communication device. In some embodiments, the information is determined based on channel state information (“CSI”) received from the communication device. In additional or alternative embodiments, determining the information associated with the communication device includes determining a type of service associated with the communication device. The type of service can include an enhanced mobile broadband (“eMBB”) service or a ultra reliable low latency communication (“URLLC”) service.

At block 930, processing circuitry 703 selects an uplink control channel configuration of the plurality of uplink control channel configurations based on the information. In some embodiments, the selected uplink control channel configuration is a PUCCH resource configuration.

In additional or alternative embodiments, selecting the uplink control channel configuration includes selecting the uplink control channel configuration based on a type of service associated with the communication device. In some examples, responsive to the type of service being an eMBB service, selecting the uplink control channel configuration includes selecting the uplink control channel configuration from the plurality of uplink control channel configurations based on the uplink control channel configuration having less symbols than another uplink control channel configuration of the plurality of uplink control channel configurations. In other examples, responsive to the type of service being a URLLC service, selecting the uplink control channel configuration includes selecting the uplink control channel configuration from the plurality of uplink control channel configurations based on the uplink control channel configuration having more symbols than another uplink control channel configuration of the plurality of uplink control channel configurations.

In additional or alternative embodiments, the information associated with the communication device includes a signal-to-noise and interference ratio (“SINR”) associated with an uplink communication channel of the communication device. Selecting the uplink control channel configuration can include determining whether the SINR exceeds a predetermined threshold value and selecting the uplink control channel configuration from the plurality of uplink control channel configurations based on whether the SINR exceeds the predetermined threshold value.

In additional or alternative embodiments, the information associated with the communication device includes a position of the communication device. Selecting the uplink control channel configuration can include selecting whether a distance between the network node and the position of the communication device exceeds a predetermined threshold value and selecting the uplink control channel configuration from the plurality of uplink control channel configurations based on whether the distance exceeds the predetermined threshold value.

At block 940, processing circuitry 703 transmits, via transceiver 701, an indication of the selected uplink control channel configuration to the communication device. In some embodiments, transmitting the indication includes transmitting downlink control information (“DCI”) that includes the indication on a downlink control channel.

At block 950, processing circuitry 703 receives, via transceiver 701, a HARQ-ACK message from the communication device. In some embodiments, the HARQ-ACK message has an uplink control channel format and a number of OFDM symbols indicated by the selected uplink control channel configuration.

Various operations of FIG. 9 may be optional with respect to some embodiments of network nodes and related methods. For example, regarding the method of Example Embodiment 1 below, for example, operations of blocks 920, 930, and 950 of FIG. 9 may be optional.

Operations of a communication device will now be discussed with reference to the flow chart of FIG. 10 according to some embodiments of inventive concepts. FIG. 10 will be described below as being performed by communication device 600 (implemented using the structure of the block diagram of FIG. 6). For example, modules may be stored in memory 605 of FIG. 6, and these modules may provide instructions so that when the instructions of a module are executed by respective processing circuitry 603, processing circuitry 603 performs respective operations of the flow chart. However, the operations in FIG. 10 may be performed by any suitable communication device.

FIG. 10 illustrates an example of operations performed by a communication device to configure an uplink control channel.

At block 1010, processing circuitry 603 receives, via transceiver 601, a plurality of uplink control channel configurations from a network node. In some embodiments, the plurality of uplink control channel configurations include a plurality of physical uplink control channel (“PUCCH”) resource configurations. Each PUCCH resource configuration can have a different number of orthogonal frequency division multiplexing (“OFDM”) symbols.

At block 1020, processing circuitry 603 transmits, via transceiver 601, CSI to the network node.

At block 1030, processing circuitry 603 receives, via transceiver 601, an indication of a selected uplink control channel configuration of the plurality of uplink control channel configurations from the network node. In some embodiments, the selected uplink control channel configuration includes a PUCCH resource configuration.

At block 1040, processing circuitry 603 transmits, via transceiver 601, a HARQ-ACK message. In some embodiments, the HARQ-ACK message has an uplink control channel format and a number of OFDM symbols indicated by the selected uplink control channel configuration.

Various operations of FIG. 10 may be optional with respect to some embodiments of communication devices and related methods. For example, regarding the method of Example Embodiment 15 below, for example, operations of blocks 1010 and 1020 of FIG. 10 may be optional.

Example Embodiments are included below.

Embodiment 1. A method performed by a network node in a communications network, the method comprising:
configuring (910) a communication device with a plurality of uplink control channel configurations each having a different number of orthogonal frequency division multiplexing, OFDM, symbols; and
transmitting (940) an indication of a selected uplink control channel configuration of the plurality of uplink control channel configurations to the communication device on a downlink control channel.

Embodiment 2. The method of Embodiment 1, wherein the plurality of uplink control channel configurations are physical uplink control channel, PUCCH, resource configurations.

Embodiment 3. The method of any of Embodiments 1-2, wherein configuring the communication device comprises configuring the communication device with the plurality of uplink control channel configurations via radio resource control, RRC, signaling.

Embodiment 4. The method of any of Embodiments 1-3, further comprising:
responsive to transmitting the indication, receiving (950) a hybrid automatic repeat request, HARQ, acknowledgment, ACK, message from the communication device, the HARQ ACK message having an uplink control channel format and a number of OFDM symbols indicated by the selected uplink control channel configuration.

Embodiment 5. The method of any of Embodiments 1-4, further comprising:
determining (920) information associated with the communication device; and
selecting (930) the uplink control channel configuration based on the information.

Embodiment 6. The method of Embodiment 5, wherein determining the information comprises:
receiving channel state information, CSI, from the communication device; and
determining the information based on the CSI.

Embodiment 7. The method of any of Embodiments 5-6, wherein determining the information associated with the communication device comprises determining a type of service associated with the communication device, and wherein selecting the uplink control channel configuration comprises selecting the uplink control channel configuration based on the type of service.

Embodiment 8. The method of Embodiment 7, wherein selecting the uplink control channel configuration based on the type of service comprises:
responsive to the type of service comprising an enhanced mobile broadband, eMBB, selecting an uplink control channel configuration having a first number of OFDM symbols; or
responsive to the type of service comprising an ultra-reliable low latency communication, URLLC, selecting an uplink control channel configuration having a second number of OFDM symbols that is greater than the first number of OFDM symbols.

Embodiment 9. The method of any of Embodiments 5-8, wherein the information associated with the communication device comprises a signal-to-noise and interference ratio, SINR, associated with an uplink communication channel of the communication device.

Embodiment 10. The method of Embodiment 9, wherein selecting the uplink control channel configuration comprises:
determining whether the SINR exceeds a predetermined SINR threshold value; and
selecting the uplink control channel configuration from the plurality of uplink control channel configurations based on whether the SINR exceeds the predetermined SINR threshold value.

Embodiment 11. The method of Embodiment 10, wherein selecting the uplink control channel configuration further comprises:
responsive to the SINR exceeding the predetermined SINR threshold value, selecting an uplink control channel configuration having a first number of OFDM symbols; or
responsive to the SINR not exceeding the predetermined SINR threshold value, selecting an uplink control channel configuration having a second number of OFDM symbols that is greater than the first number of OFDM symbols.

Embodiment 12. The method of any of Embodiments 5-11, wherein the information associated with the communication device comprises a position of the communication device within the communications network.

Embodiment 13. The method of Embodiment 12, wherein selecting the uplink control channel configuration comprises:
determining whether a distance between the network node and the position of the communication device exceeds a predetermined distance threshold value; and
selecting the uplink control channel configuration from the plurality of uplink control channel configurations based on whether the distance exceeds the predetermined distance threshold value.

Embodiment 14. The method of Embodiment 13, wherein selecting the uplink control channel configuration further comprises:
responsive to the distance not exceeding the predetermined distance threshold value, selecting an uplink control channel configuration having a first number of OFDM symbols; or
responsive to the distance exceeding the predetermined distance threshold value, selecting an uplink control channel configuration having a second number of OFDM symbols that is greater than the first number of OFDM symbols.

Embodiment 15. A method performed by a communication device in a communications network that includes a network node, the method comprising:
receiving (1030) an indication of a selected uplink control channel configuration of a plurality of uplink control channel configurations from the network node via a downlink control channel, each uplink control channel configuration of the plurality of uplink control channel configurations having a different number of orthogonal frequency division multiplexing, OFDM, symbols; and
transmitting (1040) a hybrid automatic repeat request, HARQ, acknowledgment, ACK, message to the network node, the HARQ ACK message having an uplink control channel format and a number of OFDM symbols indicated by the selected uplink control channel configuration.

Embodiment 16. The method of Embodiment 15, wherein the plurality of uplink control channel configurations are physical uplink control channel, PUCCH, resource configurations.

Embodiment 17. The method of any of Embodiments 15-16, further comprising:

receiving (1010) the plurality of uplink control channel configurations from the network node via radio resource control, RRC, signaling.

Embodiment 18. The method of any of Embodiments 15-17, further comprising:
transmitting (1020) channel state information, CSI, to the network node,
wherein receiving the indication comprises, responsive to transmitting the CSI, receiving the indication.

Embodiment 19. A network node (700) operating in a communications network, the network node comprising:
processing circuitry (703); and
memory (705) coupled to the processing circuitry and having instructions stored therein that are executable by the processing circuitry for causing the network node to perform operations, the operations comprising:
   configuring (910) a communication device with a plurality of uplink control channel configurations each having a different number of orthogonal frequency division multiplexing, OFDM, symbols; and
   transmitting (940) an indication of a selected uplink control channel configuration of the plurality of uplink control channel configurations to the communication device on a downlink control channel.

Embodiment 20. The network node of Embodiment 19, wherein the plurality of uplink control channel configurations are physical uplink control channel, PUCCH, resource configurations.

Embodiment 21. The network node of any of Embodiments 19-20, wherein configuring the communication device comprises configuring the communication device with the plurality of uplink control channel configurations via radio resource control, RRC, signaling.

Embodiment 22. The network node of any of Embodiments 19-21, the operations further comprising:

responsive to transmitting the indication, receiving (950) a hybrid automatic repeat request, HARQ, acknowledgment, ACK, message from the communication device, the HARQ ACK message having an uplink control channel format and a number of OFDM symbols indicated by the selected uplink control channel configuration.

Embodiment 23. The network node of any of Embodiments 19-22, the operations further comprising:
determining (920) information associated with the communication device; and
selecting (930) the uplink control channel configuration based on the information.

Embodiment 24. The network node of Embodiment 23, wherein determining the information comprises:
receiving channel state information, CSI, from the communication device; and
determining the information based on the CSI.

Embodiment 25. The network node of any of Embodiments 23-24, wherein determining the information associated with the communication device comprises determining a type of service associated with the communication device, and

wherein selecting the uplink control channel configuration comprises selecting the uplink control channel configuration based on the type of service.

Embodiment 26. The network node of Embodiment 25, wherein selecting the uplink control channel configuration based on the type of service comprises:
responsive to the type of service comprising an enhanced mobile broadband, eMBB, selecting an uplink control channel configuration having a first number of OFDM symbols; or
responsive to the type of service comprising an ultra-reliable low latency communication, URLLC, selecting an uplink control channel configuration having a second number of OFDM symbols that is greater than the first number of OFDM symbols.

Embodiment 27. The network node of any of Embodiments 23-26, wherein the information associated with the communication device comprises a signal-to-noise and interference ratio, SINR, associated with an uplink communication channel of the communication device.

Embodiment 28. The network node of Embodiment 27, wherein selecting the uplink control channel configuration comprises:
determining whether the SINR exceeds a predetermined SINR threshold value; and
selecting the uplink control channel configuration from the plurality of uplink control channel configurations based on whether the SINR exceeds the predetermined SINR threshold value.

Embodiment 29. The network node of Embodiment 28, wherein selecting the uplink control channel configuration further comprises:
responsive to the SINR exceeding the predetermined SINR threshold value, selecting an uplink control channel configuration having a first number of OFDM symbols; or
responsive to the SINR not exceeding the predetermined SINR threshold value, selecting an uplink control channel configuration having a second number of OFDM symbols that is greater than the first number of OFDM symbols.

Embodiment 30. The network node of any of Embodiments 23-29, wherein the information associated with the communication device comprises a position of the communication device within the communications network.

Embodiment 31. The network node of Embodiment 30, wherein selecting the uplink control channel configuration comprises:
determining whether a distance between the network node and the position of the communication device exceeds a predetermined distance threshold value; and
selecting the uplink control channel configuration from the plurality of uplink control channel configurations based on whether the distance exceeds the predetermined distance threshold value.

Embodiment 32. The network node of Embodiment 31, wherein selecting the uplink control channel configuration further comprises:
responsive to the distance not exceeding the predetermined distance threshold value, selecting an uplink control channel configuration having a first number of OFDM symbols; or
responsive to the distance exceeding the predetermined distance threshold value, selecting an uplink control channel configuration having a second number of OFDM symbols that is greater than the first number of OFDM symbols.

Embodiment 33. A network node (700) operating in a communications network, the network node adapted to perform operations, the operations including:
configuring (910) a communication device with a plurality of uplink control channel configurations each having a different number of orthogonal frequency division multiplexing, OFDM, symbols; and
transmitting (940) an indication of a selected uplink control channel configuration of the plurality of uplink control channel configurations to the communication device on a downlink control channel.

Embodiment 34. The network node of Embodiment 33, the operations further comprising any of the operations of Embodiments 2-14.

Embodiment 35. A computer program comprising program code to be executed by processing circuitry (703) of a network node (700) operating in a communications network, whereby execution of the program code causes the network node to perform operations, the operations comprising:
configuring (910) a communication device with a plurality of uplink control channel configurations each having a different number of orthogonal frequency division multiplexing, OFDM, symbols; and
transmitting (940) an indication of a selected uplink control channel configuration of the plurality of uplink control channel configurations to the communication device on a downlink control channel.

Embodiment 36. The computer program of Embodiment 35, the operations further comprising any of the operations of Embodiments 2-14.

Embodiment 37. A computer program product comprising a non-transitory storage medium including program code to be executed by processing circuitry (703) of a network node (700) operating in a communications network, whereby execution of the program code causes the network node to perform operations, the operations comprising:
configuring (910) a communication device with a plurality of uplink control channel configurations each having a different number of orthogonal frequency division multiplexing, OFDM, symbols; and
transmitting (940) an indication of a selected uplink control channel configuration of the plurality of uplink control channel configurations to the communication device on a downlink control channel.

Embodiment 38. The computer program product of Embodiment 37, the operations further comprising any of the operations of Embodiments 2-14.

Embodiment 39. A communication device (600) operating in a communications network including a network node, the communication device comprising:
processing circuitry (603); and
memory (605) coupled to the processing circuitry and having instructions stored therein that are executable by the processing circuitry for causing the communication device to perform operations, the operations comprising:
   receiving (1030) an indication of a selected uplink control channel configuration of a plurality of uplink control channel configurations from the network node via a downlink control channel, each uplink control channel configuration of the plurality of uplink control channel configurations having a different number of orthogonal frequency division multiplexing, OFDM, symbols; and
   transmitting (1040) a hybrid automatic repeat request, HARQ, acknowledgment, ACK, message to the network node, the HARQ ACK message having an uplink control channel format and a number of OFDM symbols indicated by the selected uplink control channel configuration.

Embodiment 40. The communication device of Embodiment 39, wherein the plurality of uplink control channel configurations are physical uplink control channel, PUCCH, resource configurations.

Embodiment 41. The communication device of any of Embodiments 39-40, the operations further comprising:

receiving (1010) the plurality of uplink control channel configurations from the network node via radio resource control, RRC, signaling.

Embodiment 42. The communication device of any of Embodiments 39-41, the operations further comprising:
transmitting (1020) channel state information, CSI, to the network node,
wherein receiving the indication comprises, responsive to transmitting the CSI, receiving the indication.

Embodiment 43. A communication device (600) operating in a communications network including a network node, the communication device adapted to perform operations, the operations including:
receiving (1030) an indication of a selected uplink control channel configuration of a plurality of uplink control channel configurations from the network node via a downlink control channel, each uplink control channel configuration of the plurality of uplink control channel configurations having a different number of orthogonal frequency division multiplexing, OFDM, symbols; and
transmitting (1040) a hybrid automatic repeat request, HARQ, acknowledgment, ACK, message to the network node, the HARQ ACK message having an uplink control channel format and a number of OFDM symbols indicated by the selected uplink control channel configuration.

Embodiment 44. The communication device of Embodiment 43, the operations further comprising any of the operations of Embodiments 16-18.

Embodiment 45. A computer program comprising program code to be executed by processing circuitry (603) of a communication device (600) operating in a communications network including a network node, whereby execution of the program code causes the communication device to perform operations, the operations comprising:
receiving (1030) an indication of a selected uplink control channel configuration of a plurality of uplink control channel configurations from the network node via a downlink control channel, each uplink control channel configuration of the plurality of uplink control channel configurations having a different number of orthogonal frequency division multiplexing, OFDM, symbols; and
transmitting (1040) a hybrid automatic repeat request, HARQ, acknowledgment, ACK, message to the network node, the HARQ ACK message having an uplink control channel format and a number of OFDM symbols indicated by the selected uplink control channel configuration.

Embodiment 46. The computer program of Embodiment 45, the operations further comprising any of the operations of Embodiments 16-18.

Embodiment 47. A computer program product comprising a non-transitory storage medium including program code to be executed by processing circuitry (603) of a communication device (600) operating in a communications network including a network node, whereby execution of the program code causes the communication device to perform operations, the operations comprising:
receiving (1030) an indication of a selected uplink control channel configuration of a plurality of uplink control channel configurations from the network node via a downlink control channel, each uplink control channel configuration of the plurality of uplink control channel configurations having a different number of orthogonal frequency division multiplexing, OFDM, symbols; and
transmitting (1040) a hybrid automatic repeat request, HARQ, acknowledgment, ACK, message to the network node, the HARQ ACK message having an uplink control channel format and a number of OFDM symbols indicated by the selected uplink control channel configuration.

Embodiment 48. The computer program product of Embodiment 47, the operations further comprising any of the operations of Embodiments 16-18.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 11 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 11. For simplicity, the wireless network of FIG. 11 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices’ access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 11, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 11 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB’s. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4192 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 11 that may be responsible for providing certain aspects of the network node’s functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (loT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-loT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4112 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

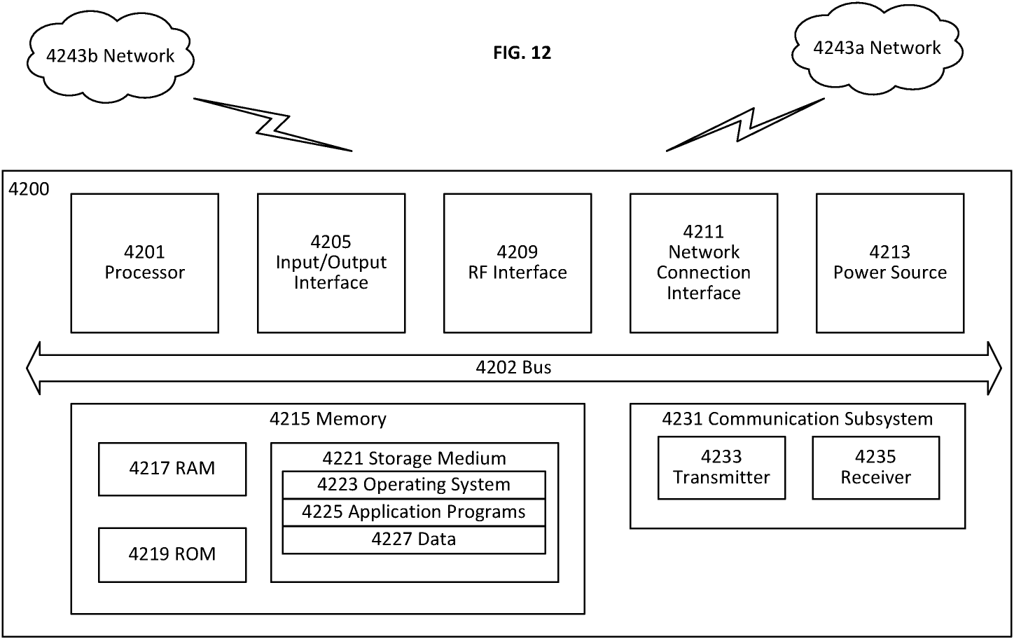

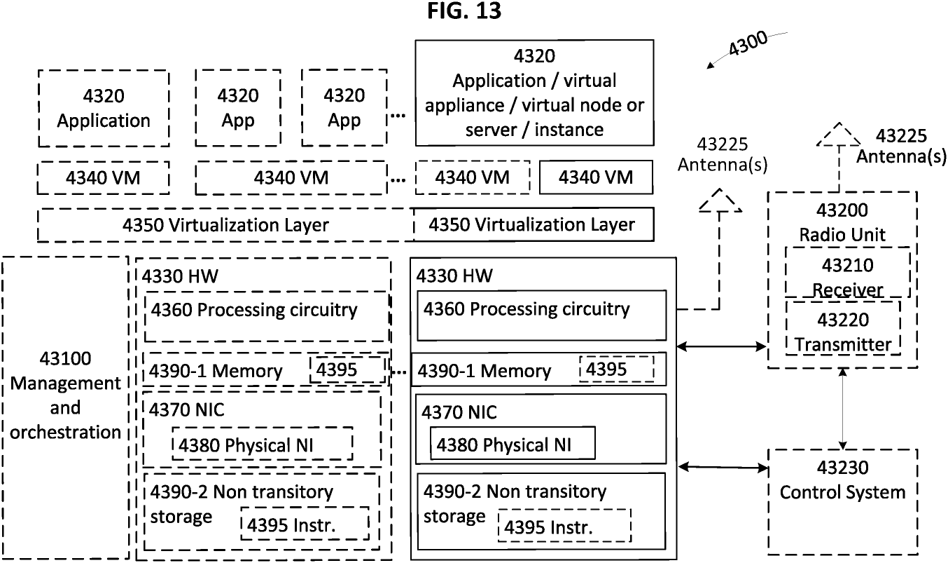

FIG. 12 illustrates a user Equipment in accordance with some embodiments.

FIG. 12 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 42200 may be any UE identified by the 3rd Generation Partnership Project (3GPP), including a NB-loT UE, a machine type communication (MTC) UE, and/or an enhanced MTC (eMTC) UE. UE 4200, as illustrated in FIG. 12, is one example of a WD configured for communication in accordance with one or more communication standards promulgated by the 3rd Generation Partnership Project (3GPP), such as 3GPP’s GSM, UMTS, LTE, and/or 5G standards. As mentioned previously, the term WD and UE may be used interchangeable. Accordingly, although FIG. 12 is a UE, the components discussed herein are equally applicable to a WD, and vice-versa.

In FIG. 12, UE 4200 includes processing circuitry 4201 that is operatively coupled to input/output interface 4205, radio frequency (RF) interface 4209, network connection interface 4211, memory 4215 including random access memory (RAM) 4217, read-only memory (ROM) 4219, and storage medium 4221 or the like, communication subsystem 4231, power source 4213, and/or any other component, or any combination thereof. Storage medium 4221 includes operating system 4223, application program 4225, and data 4227. In other embodiments, storage medium 4221 may include other similar types of information. Certain UEs may utilize all of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 4201 may be configured to process computer instructions and data. Processing circuitry 4201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 4201 may include two central processing units (CPUs). Data may be information in a form suitable for use by a computer.

In the depicted embodiment, input/output interface 4205 may be configured to provide a communication interface to an input device, output device, or input and output device. UE 4200 may be configured to use an output device via input/output interface 4205. An output device may use the same type of interface port as an input device. For example, a USB port may be used to provide input to and output from UE 4200. The output device may be a speaker, a sound card, a video card, a display, a monitor, a printer, an actuator, an emitter, a smartcard, another output device, or any combination thereof. UE 4200 may be configured to use an input device via input/output interface 4205 to allow a user to capture information into UE 4200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 4209 may be configured to provide a communication interface to RF components such as a transmitter, a receiver, and an antenna. Network connection interface 4211 may be configured to provide a communication interface to network 4243a. Network 4243a may encompass wired and/or wireless networks such as a local-area network (LAN), a wide-area network (WAN), a computer network, a wireless network, a telecommunications network, another like network or any combination thereof. For example, network 4243a may comprise a Wi-Fi network. Network connection interface 4211 may be configured to include a receiver and a transmitter interface used to communicate with one or more other devices over a communication network according to one or more communication protocols, such as Ethernet, TCP/IP, SONET, ATM, or the like. Network connection interface 4211 may implement receiver and transmitter functionality appropriate to the communication network links (e.g., optical, electrical, and the like). The transmitter and receiver functions may share circuit components, software or firmware, or alternatively may be implemented separately.

RAM 4217 may be configured to interface via bus 4202 to processing circuitry 4201 to provide storage or caching of data or computer instructions during the execution of software programs such as the operating system, application programs, and device drivers. ROM 4219 may be configured to provide computer instructions or data to processing circuitry 4201. For example, ROM 4219 may be configured to store invariant low-level system code or data for basic system functions such as basic input and output (I/O), startup, or reception of keystrokes from a keyboard that are stored in a non-volatile memory. Storage medium 4221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4221 may be configured to include operating system 4223, application program 4225 such as a web browser application, a widget or gadget engine or another application, and data file 4227. Storage medium 4221 may store, for use by UE 4200, any of a variety of various operating systems or combinations of operating systems.

Storage medium 4221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4221 may allow UE 4200 to access computer-executable instructions, application programs or the like, stored on transitory or non-transitory memory media, to off-load data, or to upload data. An article of manufacture, such as one utilizing a communication system may be tangibly embodied in storage medium 4221, which may comprise a device readable medium.

In FIG. 12, processing circuitry 4201 may be configured to communicate with network 4243b using communication subsystem 4231. Network 4243a and network 4243b may be the same network or networks or different network or networks. Communication subsystem 4231 may be configured to include one or more transceivers used to communicate with network 4243b. For example, communication subsystem 4231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 4233 and/or receiver 4235 to implement transmitter or receiver functionality, respectively, appropriate to the RAN links (e.g., frequency allocations and the like). Further, transmitter 4233 and receiver 4235 of each transceiver may share circuit components, software or firmware, or alternatively may be implemented separately.

In the illustrated embodiment, the communication functions of communication subsystem 4231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4231 may include cellular communication, Wi-Fi communication, Bluetooth communication, and GPS communication. Network 4243b may encompass wired and/or wireless networks such as a local-area network (LAN), a wide-area network (WAN), a computer network, a wireless network, a telecommunications network, another like network or any combination thereof. For example, network 4243b may be a cellular network, a Wi-Fi network, and/or a near-field network. Power source 4213 may be configured to provide alternating current (AC) or direct current (DC) power to components of UE 4200.

The features, benefits and/or functions described herein may be implemented in one of the components of UE 4200 or partitioned across multiple components of UE 4200. Further, the features, benefits, and/or functions described herein may be implemented in any combination of hardware, software or firmware. In one example, communication subsystem 4231 may be configured to include any of the components described herein. Further, processing circuitry 4201 may be configured to communicate with any of such components over bus 4202. In another example, any of such components may be represented by program instructions stored in memory that when executed by processing circuitry 4201 perform the corresponding functions described herein. In another example, the functionality of any of such components may be partitioned between processing circuitry 4201 and communication subsystem 4231. In another example, the non-computationally intensive functions of any of such components may be implemented in software or firmware and the computationally intensive functions may be implemented in hardware.

FIG. 13 illustrates a virtualization environment in accordance with some embodiments.

FIG. 13 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340 comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 13, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 13.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

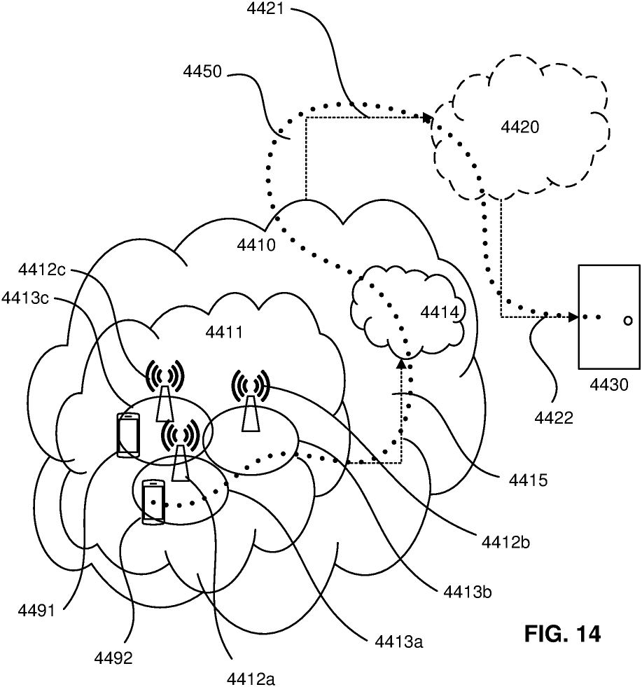

FIG. 14 illustrates a telecommunication network connected via an intermediate network to a host computer in accordance with some embodiments.

With reference to FIG. 14, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 14 as a whole enables connectivity between the connected UEs 4491, 4492 and host computer 4430. The connectivity may be described as an over-the-top (OTT) connection 4450. Host computer 4430 and the connected UEs 4491, 4492 are configured to communicate data and/or signaling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

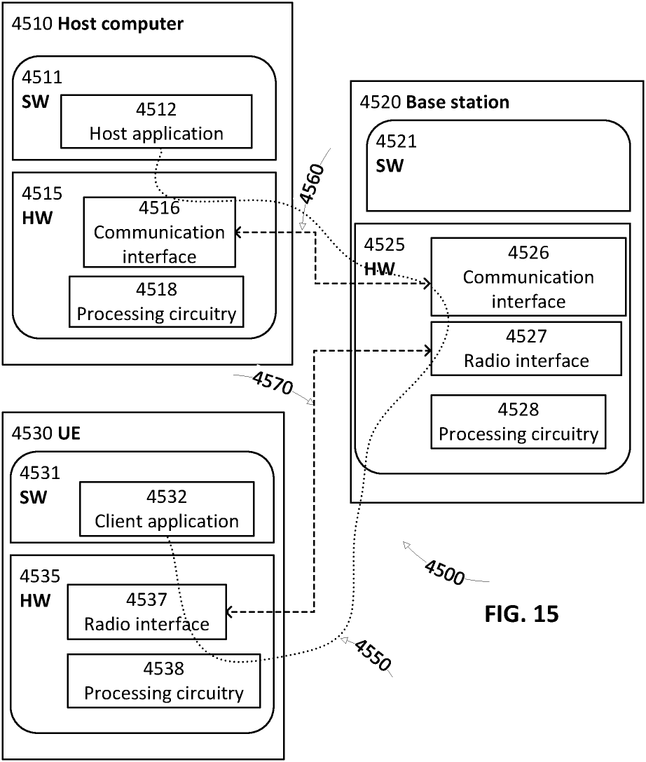

FIG. 15 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 15. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities. In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 15) served by base station 4520. Communication interface 4526 may be configured to facilitate connection 4560 to host computer 4510. Connection 4560 may be direct or it may pass through a core network (not shown in FIG. 15) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. Its hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

It is noted that host computer 4510, base station 4520 and UE 4530 illustrated in FIG. 15 may be similar or identical to host computer 4430, one of base stations 4412a, 4412b, 4412c and one of UEs 4491, 4492 of FIG. 14, respectively. This is to say, the inner workings of these entities may be as shown in FIG. 15 and independently, the surrounding network topology may be that of FIG. 14.

In FIG. 15, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signaling facilitating host computer 4510′s measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors etc.

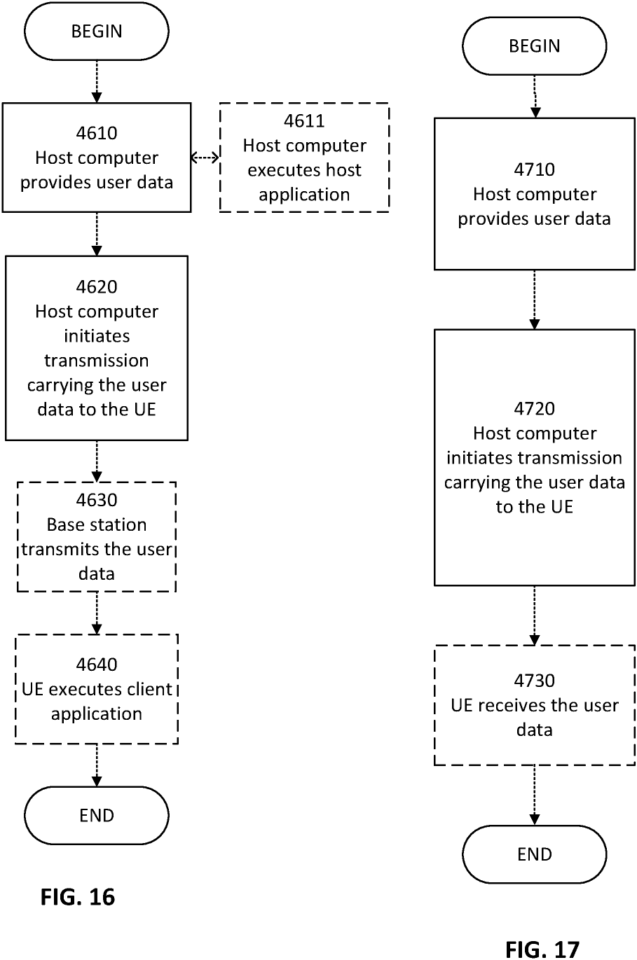

FIG. 16 illustrates methods implemented in a communication system including a host computer, a base station and a user equipment in accordance with some embodiments

FIG. 16 is a flowchart illustrating a method implemented in a communication system, in accordance with one embodiment. The communication system includes a host computer, a base station and a UE which may be those described with reference to FIGS. 15-16. For simplicity of the present disclosure, only drawing references to FIG. 16 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

FIG. 17 illustrates methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 15-16. For simplicity of the present disclosure, only drawing references to FIG. 17 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

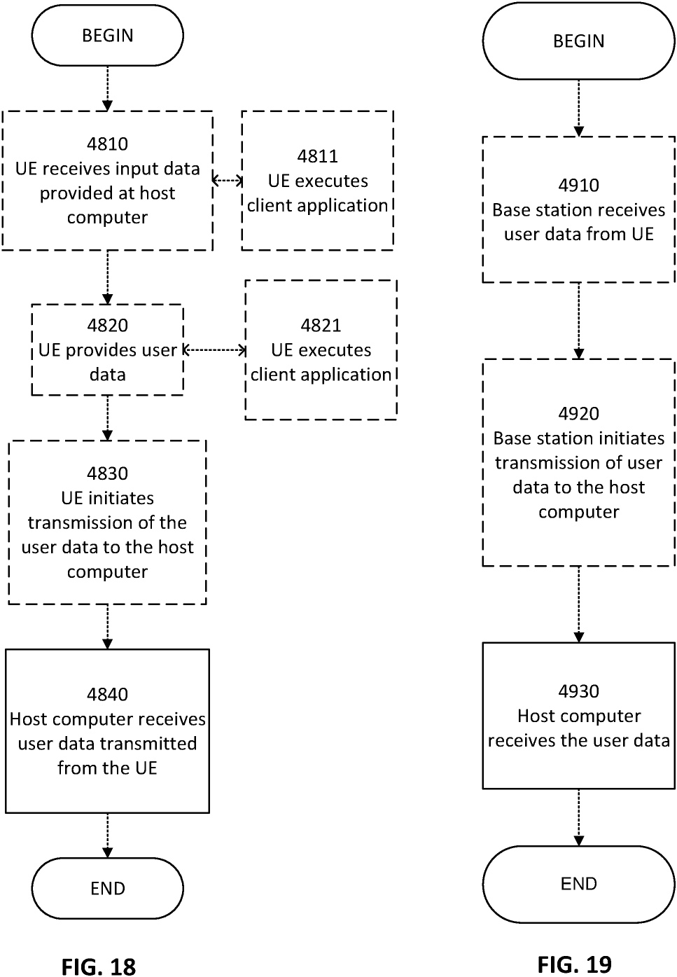

FIG. 18 illustrates methods implemented in a communication system including a host computer, a base station and a user equipment in accordance with some embodiments

FIG. 18 is a flowchart illustrating a method implemented in a communication system, in accordance with one embodiment. The communication system includes a host computer, a base station and a UE which may be those described with reference to FIGS. 15-16. For simplicity of the present disclosure, only drawing references to FIG. 18 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

FIG. 19 illustrates methods implemented in a communication system including a host computer, a base station and a user equipment in accordance with some embodiments

FIG. 19 is a flowchart illustrating a method implemented in a communication system, in accordance with one embodiment. The communication system includes a host computer, a base station and a UE which may be those described with reference to FIGS. 15-16. For simplicity of the present disclosure, only drawing references to FIG. 19 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Abbreviations

At least some of the following abbreviations may be used in this disclosure. If there is an inconsistency between abbreviations, preference should be given to how it is used above. If listed multiple times below, the first listing should be preferred over any subsequent listing(s).

| | | |
|---|---|---|
| 1x RTT | | CDMA2000 1x Radio Transmission Technology |
| 3GPP | | 3rd Generation Partnership Project |
| 5G | | 5th Generation |
| ABS | | Almost Blank Subframe |
| AMC | | Adaptive Modulation and Coding |
| ACK | | Acknowledgement |
| ARQ | | Automatic Repeat Request |
| AWGN | Additive White Gaussian Noise | |
| BCCH | | Broadcast Control Channel |
| BCH | | Broadcast Channel |
| BS | | Base Station |
| CA | | Carrier Aggregation |
| CC | | Carrier Component |
| CCCH SDU | | Common Control Channel SDU |
| CDMA Code | | Division Multiplexing Access |
| CGI | | Cell Global Identifier |
| CIR | | Channel Impulse Response |
| CP | | Cyclic Prefix |
| CPICH | Common Pilot Channel | |
| CPICH | Ec/No CPICH Received energy per chip divided by the power density in the band | |
| CQI | | Channel Quality information |
| C-RNTI | | Cell RNTI |
| CSI | | Channel State Information |
| DCCH | | Dedicated Control Channel |
| DL | | Downlink |
| DM | | Demodulation |
| DMRS | | Demodulation Reference Signal |
| DRX | | Discontinuous Reception |
| DTX | | Discontinuous Transmission |
| DTCH | | Dedicated Traffic Channel |
| DUT | | Device Under Test |
| E-CID | | Enhanced Cell-ID (positioning method) |
| E-SMLC | | Evolved-Serving Mobile Location Centre |
| ECG I | | Evolved CG I |
| eMBB | | Enhanced mobile broadband |
| eNB | | E-UTRAN NodeB |
| ePDCCH | | enhanced Physical Downlink Control Channel |
| E-SMLC | | evolved Serving Mobile Location Center |
| E-UTRA | | Evolved universal terrestrial radio access |
| E-UTRAN | | Evolved UTRAN |
| FDD | | Frequency Division Duplex |
| FFS | | For Further Study |
| GERAN | | GSM EDGE Radio Access Network |
| gNB | | Base station in NR |
| GNSS | | Global Navigation Satellite System |
| GSM | | Global System for Mobile communication |
| HARQ | | Hybrid Automatic Repeat Request |
| HO | | Handover |
| HSPA | | High Speed Packet Access |
| HRPD | | High Rate Packet Data |
| LOS | | Line of Sight |
| LPP | | LTE Positioning Protocol |
| LTE | | Long-Term Evolution |
| MAC | | Medium Access Control |
| MBMS | Multimedia Broadcast Multicast Services | |
| MBSFN | Multimedia Broadcast multicast service Single Frequency Network | |
| MBSFN ABS | | MBSFN Almost Blank Subframe |
| MDT | | Minimization of Drive Tests |
| MIB | | Master Information Block |
| MME | | Mobility Management Entity |
| MSC | | Mobile Switching Center |
| NACK | | Negative AcknowledgementNPDCCH |
| NR | | New Radio |
| OCNG | OFDMA Channel Noise Generator | |
| OFDM | | Orthogonal Frequency Division Multiplexing |
| OFDMA | | Orthogonal Frequency Division Multiple Access |
| OSS | | Operations Support System |
| OTDOA | | Observed Time Difference of Arrival |
| O&M | | Operation and Maintenance |
| PBCH | | Physical Broadcast Channel |
| P-CCPCH | | Primary Common Control Physical Channel |
| PCell | | Primary Cell |
| PCFICH | | Physical Control Format Indicator Channel |
| PDCCH | | Physical Downlink Control Channel |
| PDP | | Profile Delay Profile |
| PDSCH | | Physical Downlink Shared Channel |
| PGW | | Packet Gateway |
| PHICH | Physical Hybrid-ARQ Indicator Channel | |
| PLMN | | Public Land Mobile Network |
| PMI | | Precoder Matrix Indicator |
| PRACH | | Physical Random Access Channel |
| PRS | | Positioning Reference Signal |
| PSS | | Primary Synchronization Signal |
| PUCCH | | Physical Uplink Control Channel |
| PUSCH | | Physical Uplink Shared Channel |
| RACH | | Random Access Channel |
| QAM | | Quadrature Amplitude Modulation |
| RAN | | Radio Access Network |
| RAT | | Radio Access Technology |
| RLM | | Radio Link Management |
| RNC | | Radio Network Controller |
| RNTI | | Radio Network Temporary Identifier |
| RRC | | Radio Resource Control |
| RRM | | Radio Resource Management |
| RS | | Reference Signal |
| RSCP | | Received Signal Code Power |
| RSRP | | Reference Symbol Received Power OR |
| | Reference Signal Received Power | |
| RSRQ | | Reference Signal Received Quality OR |
| | Reference Symbol Received Quality | |
| RSSI | | Received Signal Strength Indicator |
| RSTD | | Reference Signal Time Difference |
| SCH | | Synchronization Channel |
| SCell | | Secondary Cell |
| SDU | | Service Data Unit |
| SFN | | System Frame Number |
| SGW | | Serving Gateway |
| SI | | System Information |
| SIB | | System Information Block |
| SINR | | Signal-to-Interference-and-Noise Ratio |
| SNR | | Signal to Noise Ratio |
| SON | | Self Optimized Network |
| SS | | Synchronization Signal |
| SSS | | Secondary Synchronization Signal |
| TDD | | Time Division Duplex |
| TDOA | | Time Difference of Arrival |
| TOA | | Time of Arrival |
| TSS | | Tertiary Synchronization Signal |
| TTI | | Transmission Time Interval |
| Tx | | Transmitter |
| UE | | User Equipment |
| UL | | Uplink |
| UMTS | | Universal Mobile Telecommunication System |
| URLLC | | Ultra-Reliable Low Latency Communication |
| USIM | | Universal Subscriber Identity Module |
| UTDOA | | Uplink Time Difference of Arrival |
| UTRA | | Universal Terrestrial Radio Access |
| UTRAN | | Universal Terrestrial Radio Access Network |
| WCDMA | | Wide CDMA |
| WLAN | | Wide Local Area Network |

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a network node in a communications network, the method comprising:
configuring a communication device with a plurality of uplink control channel configurations each having a different number of orthogonal frequency division multiplexing, OFDM, symbols; and
transmitting an indication of a selected uplink control channel configuration of the plurality of uplink control channel configurations to the communication device on a downlink control channel further comprising:
determining information associated with the communication device; and
selecting the uplink control channel configuration based on the information, wherein determining the information comprises:
receiving channel state information, CSI, from the communication device; and
determining the information based on the CSI.

2. The method of claim 1, wherein the plurality of uplink control channel configurations are physical uplink control channel, PUCCH, resource configurations.

3. The method of claim 1, wherein configuring the communication device comprises configuring the communication device with the plurality of uplink control channel configurations via radio resource control, RRC, signaling.

4. The method of claim 1, further comprising:
responsive to transmitting the indication, receiving a hybrid automatic repeat request, HARQ, acknowledgment, ACK, message from the communication device, the HARQ ACK message having an uplink control channel format and a number of OFDM symbols indicated by the selected uplink control channel configuration.

5-6. (canceled)

7. The method of claim 1, wherein determining the information associated with the communication device comprises determining a type of service associated with the communication device, and
wherein selecting the uplink control channel configuration comprises selecting the uplink control channel configuration based on the type of service.

8. The method of claim 7, wherein selecting the uplink control channel configuration based on the type of service comprises:
responsive to the type of service comprising an enhanced mobile broadband, eMBB service, selecting an uplink control channel configuration having a first number of OFDM symbols; and
responsive to the type of service comprising an ultra-reliable low latency communication, URLLC service, selecting an uplink control channel configuration having a second number of OFDM symbols that is greater than the first number of OFDM symbols.

9. The method of claim 1, wherein the information associated with the communication device comprises a signal-to-noise and interference ratio, SINR, associated with an uplink communication channel of the communication device.

10. The method of claim 9, wherein selecting the uplink control channel configuration comprises:
determining whether the SINR exceeds a predetermined SINR threshold value; and
selecting the uplink control channel configuration from the plurality of uplink control channel configurations based on whether the SINR exceeds the predetermined SINR threshold value.

11. The method of claim 10, wherein selecting the uplink control channel configuration further comprises:
responsive to the SINR exceeding the predetermined SINR threshold value, selecting an uplink control channel configuration having a first number of OFDM symbols; or
responsive to the SINR not exceeding the predetermined SINR threshold value, selecting an uplink control channel configuration having a second number of OFDM symbols that is greater than the first number of OFDM symbols.

12. The method of claim 1, wherein the information associated with the communication device comprises a position of the communication device within the communications network.

13. The method of claim 12, wherein selecting the uplink control channel configuration comprises:
determining whether a distance between the network node and the position of the communication device exceeds a predetermined distance threshold value; and
selecting the uplink control channel configuration from the plurality of uplink control channel configurations based on whether the distance exceeds the predetermined distance threshold value.

14. The method of claim 13, wherein selecting the uplink control channel configuration further comprises:
responsive to the distance not exceeding the predetermined distance threshold value, selecting an uplink control channel configuration having a first number of OFDM symbols; or
responsive to the distance exceeding the predetermined distance threshold value, selecting an uplink control channel configuration having a second number of OFDM symbols that is greater than the first number of OFDM symbols.

15. A method performed by a communication device in a communications network that includes a network node, the method comprising:
receiving an indication of a selected uplink control channel configuration of a plurality of uplink control channel configurations from the network node via a downlink control channel, each uplink control channel configuration of the plurality of uplink control channel configurations having a different number of orthogonal frequency division multiplexing, OFDM, symbols; and
transmitting a hybrid automatic repeat request, HARQ, acknowledgment, ACK, message to the network node, the HARQ ACK message having an uplink control channel format and a number of OFDM symbols indicated by the selected uplink control channel configuration further comprising:
transmitting channel state information, CSI, to the network node, wherein receiving the indication comprises, responsive to transmitting the CSI, receiving the indication.

16. The method of claim 15, wherein the plurality of uplink control channel configurations are physical uplink control channel, PUCCH, resource configurations.

17. The method of claim 15, further comprising:
receiving the plurality of uplink control channel configurations from the network node via radio resource control, RRC, signaling.

18. (canceled)

19. A network node operating in a communications network, the network node comprising:
processing circuitry; and
memory coupled to the processing circuitry and having instructions stored therein that are executable by the processing circuitry for causing the network node to perform operations, the operations comprising:
configuring a communication device with a plurality of uplink control channel configurations each having a different number of orthogonal frequency division multiplexing, OFDM, symbols; and
transmitting an indication of a selected uplink control channel configuration of the plurality of uplink control channel configurations to the communication device on a downlink control channel further comprising:
determining information associated with the communication device; and
selecting the uplink control channel configuration based on the information wherein determining the information comprises:
receiving channel state information, CSI, from the communication device; and
determining the information based on the CSI.

20. The network node of claim 19, further configured to perform a method comprising:
configuring a communication device with a plurality of uplink control channel configurations each having a different number of orthogonal frequency division multiplexing, OFDM, symbols; and
transmitting an indication of a selected uplink control channel configuration of the plurality of uplink control channel configurations to the communication device on a downlink control channel further comprising:
determining information associated with the communication device; and
selecting the uplink control channel configuration based on the information, wherein determining the information comprises:
receiving channel state information, CSI, from the communication device; and
determining the information based on the CSI,
wherein the plurality of uplink control channel configurations are physical uplink control channel, PUCCH, resource configurations.

21-38. (canceled)

39. A communication device operating in a communications network including a network node, the communication device comprising:
processing circuitry; and
memory coupled to the processing circuitry and having instructions stored therein that are executable by the processing circuitry for causing the communication device to perform operations, the operations comprising:
receiving an indication of a selected uplink control channel configuration of a plurality of uplink control channel configurations from the network node via a downlink control channel, each uplink control channel configuration of the plurality of uplink control channel configurations having a different number of orthogonal frequency division multiplexing, OFDM, symbols; and
transmitting a hybrid automatic repeat request, HARQ, acknowledgment, ACK, message to the network node, the HARQ ACK message having an uplink control channel format and a number of OFDM symbols indicated by the selected uplink control channel configuration, the operations further comprising:
transmitting channel state information, CSI, to the network node, wherein receiving the indication comprises, responsive to transmitting the CSI, receiving the indication.

40. The communication device of claim 39, wherein the plurality of uplink control channel configurations are physical uplink control channel, PUCCH, resource configurations.

41. The communication device of claim 39, the operations further comprising:
receiving the plurality of uplink control channel configurations from the network node via radio resource control, RRC, signaling.

42-44. (canceled)

45. A computer program comprising program code to be executed by processing circuitry of a communication device operating in a communications network or by processing circuitry of a network node, whereby execution of the program code causes the communication device to perform any of the operations defined by claim 15, or causes the network node in a communications network to:
configure a communication device with a plurality of uplink control channel configurations each having a different number of orthogonal frequency division multiplexing, OFDM, symbols; and
transmit an indication of a selected uplink control channel configuration of the plurality of uplink control channel configurations to the communication device on a downlink control channel, wherein the operation further comprises:
determining information associated with the communication device; and
selecting the uplink control channel configuration based on the information, wherein determining the information comprises:
receiving channel state information, CSI, from the communication device; and determining the information based on the CSI .

46. (canceled)

47. A computer program product comprising a non-transitory storage medium including program code corresponding to claim 45
.

48. (canceled)
